(19) United States
(12) Patent Application Publication
(10) Pub. No.: US 2026/0287773 A1
(43) Pub. Date: Sep. 24, 2026

(54) STRETCH-FREE NORMAL MOVEOUT AND STACKING WITH TIME-SHIFT COMMON MIDPOINT GATHERS

(71) Applicant: Saudi Arabian Oil Company, Dhahran (SA)

(72) Inventor: YUJIN LIU, Beijing (CN)

(73) Assignee: Saudi Arabian Oil Company, Dhahran (SA)

(21) Appl. No.: 18/721,072

(22) PCT Filed: May 6, 2024
(86) PCT No.: PCT/IB2024/054391

§ 371 Date: Jun. 17, 2024

(51) Int. Cl. G01V 1/30; G01V 1/36

(52) U.S. Cl. CPC G01V 1/301; G01V 1/362; G01V 2210/52

(57) ABSTRACT

A stretch-free normal moveout (NMO) with time-shift common midpoint (CMP) stacking to generate an improved seismic image. A time-shift CMP is generated that preserves the constant time shift (also referred as lag). A least-squares parallel NMO correction is applied to the time-shift CMP gather by minimizing an objective function. The time-shift CMP gather is then stacked along a determined trajectory (the time-shift axis) to produce a final stacked trace free of stretch effects.

### CROSS-REFERENCE TO RELATED APPLICATIONS

This application claims the benefit and priority of PCT/IB24/54391 filed on May 6, 2024, and titled “Stretch-Free Normal Moveout and Stacking with Time-Shift Common Midpoint Gathers”. For purposes of United States patent practice, this application incorporates the contents of the International Application by reference in its entirety.

### BACKGROUND

### Field of the Disclosure

The present disclosure generally relates to geophysical exploration using seismic surveying. More specifically, embodiments of the disclosure relate to a stretch-free normal moveout (NMO) correction in the generation of seismic images.

### Description of the Related Art

In geophysical exploration, such as the exploration for hydrocarbons, seismic surveys are performed to produce images of the various rock formations in the earth (“subsurface”) or underwater (“subsea”). The seismic surveys obtain seismic data indicating the response of the rock formations to the travel of elastic wave seismic energy. A number of processing techniques may be used to address complexities in processing and interpreting the seismic data, due to the various types of seismic waves, locations of seismic sources and seismic receivers, etc.

### SUMMARY

Normal moveout (NMO) correction is a process that compensates for the increase in travel time of seismic waves with offset. Normal moveout (NMO) correction is routinely applied to traces of each common mid-point (CMP) gather before forming a stack section. The correction removes the moveout effect on travel times, and the resulting data is used to create a stacked section.

NMO refers to the difference between the two-way time at a given offset and the two-way zero-offset time is called NMO, which can be expressed as the following:

$$Δ t ( {t}_{0} , h ) = t ( {t}_{0} , h ) - {t}_{0} \qquad ( 1 )$$

where Δt(t₀, h) is the moveout time, t₀ is the two-way time at the zero offset, h is the source-to-receiver offset, and t(t₀, h) is the travel time corresponding to t₀ at an offset h.

In the layered vertically transversely isotropic media, t is approximately hyperbolic for offset-depth ratio less than 1, which may be expressed as follows:

$$t ( {t}_{0} , h ) = \sqrt{{t}_{0}^{2} + \frac{{h}^{2}}{{v}_{rms}^{2}}} \qquad ( 2 )$$

where vᵣₘₛ is the root-mean-square velocity at t₀.

When data has a high offset-depth ratio, the hyperbolic approximation cannot accurately calculate long-offset travel time. To address this issue, a fourth-order equation may be used and is expressed as follows:

$$t ( {t}_{0} , h ) = \sqrt{{t}_{0}^{2} + \frac{{h}^{2}}{{v}_{rms}^{2}} + \frac{{v}_{rms}^{4} - {v}_{4}^{4}}{4 {t}_{0}^{4} {v}_{rms}^{8}} {h}^{4}} \qquad ( 3 )$$

where v₄ is the quartic velocity. The quartic velocity at the layer N is computed by the following:

$${v}_{4} = \sqrt[4]{\frac{{\sum }_{i = 1}^{N} Δ {t}_{i} {v}_{i}^{4}}{{\sum }_{i = 1}^{N} Δ {t}_{i}}} \qquad ( 4 )$$

where vᵢ is the interval velocity of the i-th layer after Dix conversion of the rms velocity, and Δtᵢ is the vertical travel time of the ith layer.

Due to the convergence of NMO trajectories, different values of Δt apply to different samples of a reflected wavelet; however, the reflected wavelet at a particular offset should have a constant moveout. This leads to the wavelet stretching effect. By way of example, FIG. 1A is schematic diagram of NMO for three samples from the same wavelet at a specific offset having a different moveout. As shown in FIG. 1A, three samples from the same wavelet at a specific offset have different moveout time. This causes the wavelet stretching at non-zero offsets, especially at far offsets.

After NMO correction, stacking is performed on each CMP gather to improve the signal-to-noise ratio (SNR) of the image at the corresponding CMP location. A typical stacking formula may be expressed as follows:

$$I ( {t}_{0} ) = \int d ( {t}_{0} + Δ t ( {t}_{0} , h ) , h ) dh \qquad ( 5 )$$

Once the seismic data is stacked, the signal-to-noise ratio (SNR) of the image will be significantly enhanced compared to the zero-offset profile. However, as a result of the NMO stretching effect, the resolution of the stacked image will lower than that of the zero-offset profile. In a typical seismic data processing workflow, the stretch effect is muted before stacking. However, identifying the muting area is labor-intensive and prone to human bias. Moreover, as explained supra and shown in FIG. 1A, stretching occurs everywhere except at zero offset, so muting cannot completely resolve the issue of stretching effects.

Some techniques may avoid the NMO stretching effect by ensuring a constant moveout is used at any point within a reflected wavelet (so-called “parallel” NMO). This may be performed by applying a parallel NMO correction to the CMP gather according to the following:

$${Δ}^{′} t ( {t}_{0} , h ) = Δ t ( {t}_{0} , h ) + τ \qquad ( 6 )$$

where τ is a constant time around the onset of a reflected wavelet. FIG. 1B is a schematic diagram showing the parallel NMO correction applied to the CMP gather according to Equation 6. This type of NMO correction does not fully avoid the stretching effect and does not preserve amplitude information after stacking.

Embodiments of the disclosure are directed to a stretch-free least-squares parallel NMO correction from time-shift CMP gathers. The least-squares parallel NMO corrected time-shift CMP gathers are summed in the time-shift dimension along a determined trajectory. Embodiments of the disclosure avoid stretch effects, enhance the resolution of the stack image, and preserve amplitude information for lithology interpretation.

In one embodiment, a computer-implemented method for constructing a seismic image from seismic data generated from a seismic receiver station configured to sense seismic signals originating from a seismic source station is provided. The method includes obtaining the seismic data generated from the seismic receiver station, generating time-shift common midpoint (CMP) gathers from the seismic data, and applying a least squared normal moveout (NMO) correction to the time-shift CMP gathers. The method also includes stacking the time-shift CMP gathers along a time-shift axis and constructing a seismic image from the stacked time-shift CMP gathers.

In some embodiments, stacking the time-shift CMP gathers along the time-shift axis includes determining a trajectory of the time-shift CMP gather in the time domain and stacking along the determined trajectory. In some embodiments, determining the trajectory of the time-shift CMP gather includes:

$$t ( τ ) = {t}_{0} - τ ,$$

where t is the travel time at the time shift τ and t₀ is the two-way time at the zero offset. In some embodiments, stacking along the determined trajectory includes:

$$M ( {t}_{0} ) = \int I ( {t}_{0} - τ , τ ) d τ ,$$

where M(t₀) is the stacked trace, τ is the time shift, t₀ is the two-way time at the zero offset, and I is the time-shift gather. In some embodiments, generating the time-shift common midpoint (CMP) gathers from the seismic data includes:

$$I ( {t}_{0} , τ ) = \int d ( {t}_{0} + Δ t ( {t}_{0} , h ) + τ , h ) dh .$$

where I is the time-shift CMP gather, τ is the time shift, t₀ is the two-way time at the zero offset, and h is the source-to-receiver offset. In some embodiments, applying the least squared normal moveout (NMO) correction to the time-shift common midpoint gathers includes minimizing the following objective function:

$$J ( m ) = {‖ Lm - d ‖}^{2} ,$$

where m is the optimal time-shift common mid-point gather, d is the input common mid-point gather, L is the operator mapping from the time-shift CMP gather to an original CMP gather. In some embodiments, L is the expression:

$$d ( {t}_{0} , h ) = \int I ( {t}_{0} - Δ t ( {t}_{0} , h ) - τ , τ ) d τ .$$

where I is the time-shift CMP gather, τ is the time shift, t₀ is the two-way time at the zero offset, and h is the source-to-receiver offset.

In another embodiment, a non-transitory computer-readable storage medium having executable code stored thereon for constructing a seismic image from seismic data generated from a seismic receiver station configured to sense seismic signals originating from a seismic source station is provided. The executable code has a set of instructions that causes a processor to perform operations that include obtaining the seismic data generated from the seismic receiver station, generating time-shift common midpoint (CMP) gathers from the seismic data, and applying a least squared normal moveout (NMO) correction to the time-shift CMP gathers. The operations also include stacking the time-shift CMP gathers along a time-shift axis and constructing a seismic image from the stacked time-shift CMP gathers.

In some embodiments, stacking the time-shift CMP gathers along the time-shift axis includes determining a trajectory of the time-shift CMP gather in the time domain and stacking along the determined trajectory. In some embodiments, determining the trajectory of the time-shift CMP gather includes:

$$t ( τ ) = {t}_{0} - τ ,$$

where t is the travel time at the time shift τ and t₀ is the two-way time at the zero offset. In some embodiments, stacking along the determined trajectory includes:

$$M ( {t}_{0} ) = \int I ( {t}_{0} - τ , τ ) d τ ,$$

where M(t₀) is the stacked trace, τ is the time shift, t₀ is the two-way time at the zero offset, and I is the time-shift gather. In some embodiments, generating the time-shift common midpoint (CMP) gathers from the seismic data includes:

$$I ( {t}_{0} , τ ) = \int d ( {t}_{0} + Δ t ( {t}_{0} , h ) + τ , h ) dh .$$

where I is the time-shift CMP gather, τ is the time shift, t₀ is the two-way time at the zero offset, and h is the source-to-receiver offset. In some embodiments, applying the least squared normal moveout (NMO) correction to the time-shift common midpoint gathers includes minimizing the following objective function:

$$J ( m ) = {‖ Lm - d ‖}^{2} ,$$

where m is the optimal time-shift common mid-point gather, d is the input common mid-point gather, L is the operator mapping from the time-shift CMP gather to an original CMP gather. In some embodiments, L is the expression:

$$d ( {t}_{0} , h ) = \int I ( {t}_{0} - Δ t ( {t}_{0} , h ) - τ , τ ) d τ .$$

where I is the time-shift CMP gather, τ is the time shift, t₀ is the two-way time at the zero offset, and h is the source-to-receiver offset.

In another embodiment, a system is provided that includes a seismic source station, a seismic receiver station configured to sense seismic signals originating from a seismic source station, a seismic data processor, and a non-transitory computer-readable storage memory accessible by the seismic data processor and having executable code stored thereon for constructing a seismic image from seismic data generated from the seismic receiver station. The executable code has a set of instructions that causes a processor to perform operations that include obtaining the seismic data generated from the seismic receiver station, generating time-shift common midpoint (CMP) gathers from the seismic data, and applying a least squared normal moveout (NMO) correction to the time-shift CMP gathers. The operations also include stacking the time-shift CMP gathers along a time-shift axis and constructing a seismic image from the stacked time-shift CMP gathers.

In some embodiments, stacking the time-shift CMP gathers along the time-shift axis includes determining a trajectory of the time-shift CMP gather in the time domain and stacking along the determined trajectory. In some embodiments, determining the trajectory of the time-shift CMP gather includes:

$$t ( τ ) = {t}_{0} - τ ,$$

where t is the travel time at the time shift τ and t₀ is the two-way time at the zero offset. In some embodiments, stacking along the determined trajectory includes:

$$M ( {t}_{0} ) = \int I ( {t}_{0} - τ , τ ) d τ ,$$

where M(t₀) is the stacked trace, τ is the time shift, t₀ is the two-way time at the zero offset, and I is the time-shift gather. In some embodiments, generating the time-shift common midpoint (CMP) gathers from the seismic data includes:

$$I ( {t}_{0} , τ ) = \int d ( {t}_{0} + Δ t ( {t}_{0} , h ) + τ , h ) dh .$$

where I is the time-shift CMP gather, τ is the time shift, t₀ is the two-way time at the zero offset, and h is the source-to-receiver offset. In some embodiments, applying the least squared normal moveout (NMO) correction to the time-shift common midpoint gathers includes minimizing the following objective function:

$$J ( m ) = {‖ Lm - d ‖}^{2} ,$$

where m is the optimal time-shift common mid-point gather, d is the input common mid-point gather, L is the operator mapping from the time-shift CMP gather to an original CMP gather. In some embodiments, L is the expression:

$$d ( {t}_{0} , h ) = \int I ( {t}_{0} - Δ t ( {t}_{0} , h ) - τ , τ ) d τ .$$

where I is the time-shift CMP gather, τ is the time shift, t₀ is the two-way time at the zero offset, and h is the source-to-receiver offset.

### BRIEF DESCRIPTION OF THE DRAWINGS

FIG. 1A is a schematic diagram of prior art normal moveout (NMO);

FIG. 1B is a schematic diagram of prior art parallel normal moveout (NMO);

FIG. 2 is a block diagram of a process for generating a seismic image by performing a stretch-free normal moveout (NMO) and stacking with time-shift common midpoint gathers (CMPs) in accordance with an embodiment of the disclosure;

FIG. 3A depicts a synthetic layered earth model in accordance with an embodiment of the disclosure;

FIG. 3B depicts a synthetic CMP gather from the synthetic layered earth model of FIG. 3A obtained by Kirchhoff modeling;

FIG. 3C depicts a CMP gather after NMO correction of the CMP gather of FIG. 3B;

FIG. 4A depicts time-shift CMP gathers from the model of FIG. 3A after parallel NMO correction;

FIG. 4B depicts time-shift CMP gathers from the model of FIG. 3A after least-squares parallel NMO in accordance with the embodiments of the disclosure;

FIG. 5A depicts flattened time-shift CMP gathers from the model of FIG. 3A after parallel NMO correction;

FIG. 5B depicts flattened time-shift CMP gathers from the model of FIG. 3A after least-squares parallel NMO in accordance with embodiments of the disclosure;

FIG. 6A depicts a stacked offset trace generated from the model of FIG. 3A after application of conventional NMO;

FIG. 6B depicts a stacked trace generated from the model of FIG. 3A after application of conventional NMO;

FIG. 6C depicts a stacked trace generated from the model of FIG. 3A after application of parallel NMO and flattening;

FIG. 6D depicts a depicts a stacked trace generated from the model of FIG. 3A after application of least-squares parallel NMO and flattening in accordance with an embodiment of the disclosure;

FIG. 7A depicts a synthetic velocity model overlaid by several reflectors;

FIG. 7B depicts a synthetic CMP gather from the model of FIG. 7A and with added random noise;

FIG. 7C depicts a CMP gather after conventional NMO correction of the CMP gather of FIG. 7B;

FIG. 8A depicts the flattened time-shift CMP gathers from the model of FIG. 7A after parallel NMO correction;

FIG. 8B depicts the flattened time-shift CMP gathers from the model of FIG. 7A after application of a least-squares parallel NMO correction in accordance with an embodiment of the disclosure;

FIG. 9A depicts a stacked zero-offset image generated from the model of FIG. 7A;

FIG. 9B depicts a stacked image generated from the model of FIG. 7A after application of conventional NMO;

FIG. 9C depicts a stacked image generated from the model of FIG. 7A after application of parallel NMO and stacking of time-shift CMP gathers;

FIG. 9D depicts a stacked trace generated from the model of FIG. 7A after application of least-squares parallel NMO and stacking of flattened time-shift CMP gathers in accordance with an embodiment of the disclosure;

FIG. 10 is a block diagram of a system for producing seismic data and a seismic image in accordance with an embodiment of the disclosure; and

FIG. 11 a block diagram of a seismic data processing system in accordance with an embodiment of the disclosure

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Conventional NMO correction has the drawback of producing stretching as a natural result of convergence of the NMO trajectories. The stretching causes low-resolution stacking image, velocity analysis with high uncertainty, and unreliable amplitude versus offset (AVO) at far offset. If muting the stretching part of each CMP gather, it will cause loss of fold, resulting in low signal-to-noise ratio of stacked image. Additionally, muting will cause loss of far offset, leading to less multiple suppression, inaccurate velocity analysis, and loss of valuable AVO information.

Embodiments of the disclosure are directed to a stretch-free normal moveout (NMO) with time-shift common midpoint (CMP) stacking to generate an improved seismic image. A time-shift CMP is generated that preserves the constant time shift (also referred as lag) and avoids computationally intensive migration. A least-squares parallel NMO correction is applied to the time-shift CMP gather by minimizing an objective function. The time-shift CMP gather is then stacked along a determined trajectory (the time-shift axis) to produce a final stacked trace (and seismic image) free of stretch effects. In addition to avoiding a stretching effect, the stacked trace has improved preservation of amplitude information and a reduced SNR.

FIG. 2 is a block diagram 200 of a process 200 for generating a seismic image by performing a stretch-free normal moveout (NMO) and stacking with time-shift common midpoint gathers (CMPs) in accordance with an embodiment of the disclosure. Initially, seismic data having uncorrected gathers is obtained (block 202). Seismic data may be obtained from a seismic survey of an area of interest employing combinations of seismic sources and seismic receivers.

Next, time shift CMP gather is generated from the uncorrected gathers by preserving a constant time shift during stacking (block 204). The time shift CMP is generated according to the following:

$$I ( {t}_{0} , τ ) = \int d ( {t}_{0} + Δ t ( {t}_{0} , h ) + τ , h ) dh \qquad ( 7 )$$

Next, a least-squares parallel NMO correction is performed (block 206). Parallel normal moveout might give poor results for overlapping events with different velocities. The parallel NMO correction and stacking are solved as an inverse problem. The solution is determined by minimizing the following objective function:

$$J ( m ) = {‖ Lm - d ‖}^{2} \qquad ( 8 )$$

where m is the optimal time-shift common mid-point gather, d is the input common mid-point gather, L is the operator mapping from the time-shift CMP gather to the original CMP gather. L is the adjoint of the operator described by Equation 7 and may be expressed as:

$$d ( {t}_{0} , h ) = \int I ( {t}_{0} - Δ t ( {t}_{0} , h ) - τ , τ ) d τ \qquad ( 9 )$$

Next, as shown in FIG. 2, the time-shift CMP gathers are stacked (block 208). The time-shift CMP gather I(t₀, τ) along the time-shift axis. The trajectory of time-shift gather in the depth domain may be derived as follows:

$$z ( τ ) = \frac{{z}_{0} {s}_{0} - \frac{τ}{2}}{s} \qquad ( 10 )$$

where so is the true slowness, z₀ is the true depth, and z is migration depth using migration slowness z. Using the relationship between the two-way vertical time and the depth, equation 10 may be transformed in the time domain as the following:

$$t ( τ ) = {t}_{0} - τ \qquad ( 11 )$$

where t is the travel time at the time shift τ. Stacking along the trajectory equation determined by Equation 11 provides coherent stacking result for generation of a seismic image. Moreover, the stacking trajectory determined by Equation 11 is independent of velocity. After determining the stacking trajectory, the stacking procedure may be performed according to the following:

$$M ( {t}_{0} ) = \int I ( {t}_{0} - τ , τ ) d τ \qquad ( 12 )$$

where M(t₀) is the final stacked trace that will be free of stretch effects. An improved seismic image for the area of interest is generated from the final stacked trace (block 210). The seismic image may be used to determine locations for drilling a well to access a reservoir in the area of interest. For example, as discussed in the examples supra, the seismic image from the final stacked trace preserves amplitude information and enables interpretation of lithologies in the area of interest using the seismic image.

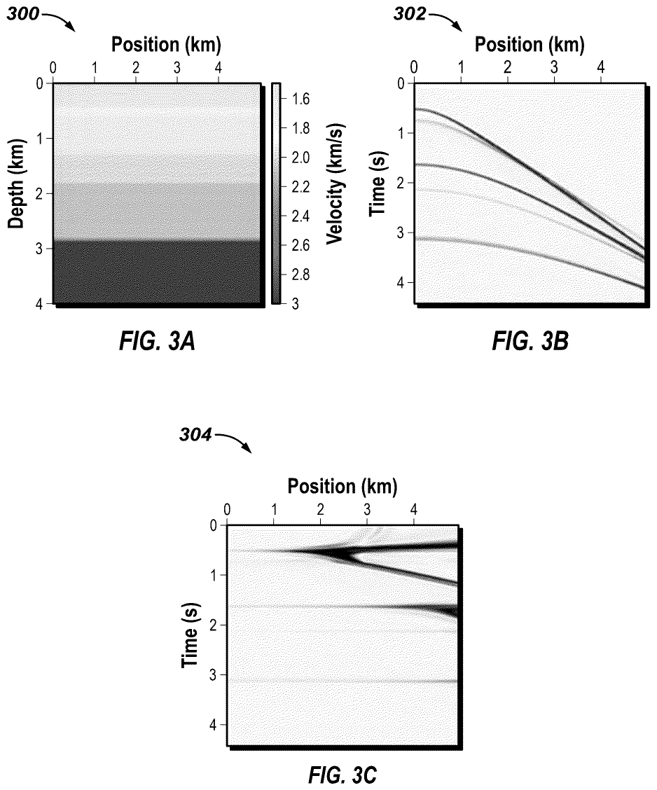

The performance of embodiments of the disclosure was evaluated using two synthetic models. The first model was a layered-earth model, the processing of which and resulting stacked gathers are depicted in FIGS. 3A-2C, 4A-4B, 5A-5B, and 6A-6D. FIG. 3A depicts the synthetic layered earth model 300 used in the evaluation. FIG. 3B depicts the synthetic CMP gather 302 from the synthetic layered earth model of FIG. 3A obtained by Kirchhoff modeling, and FIG. 3C is the CMP gather 304 after NMO correction without any attempts to mitigate NMO stretching. As shown in FIG. 3C, the CMP gather exhibits significant stretch effects, especially at the shallow and far-offset portions.

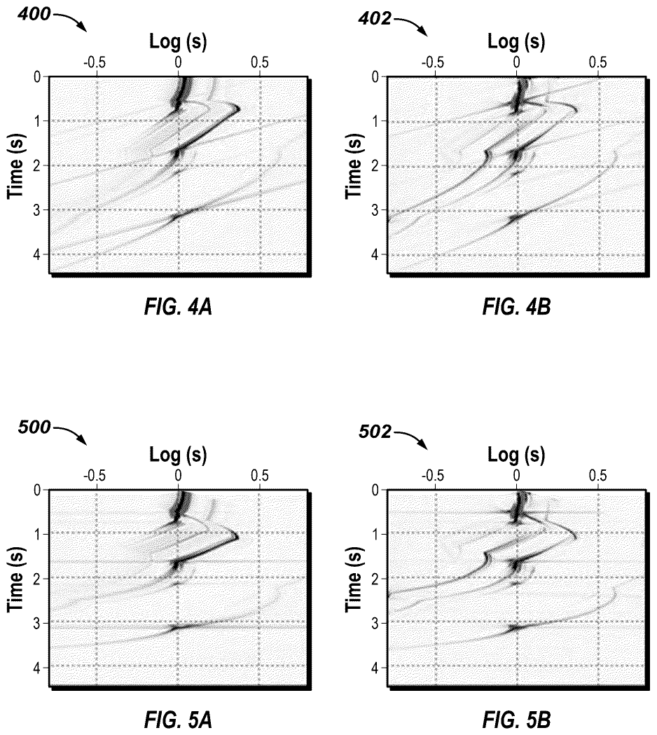

FIG. 4A shows the time-shift CMP gathers 400 from the model of FIG. 3A after parallel NMO correction. FIG. 4B shows the time-shift CMP gathers 402 from the model of FIG. 3A after least-squares parallel NMO in accordance with the techniques of the disclosure. As shown in these figures, slant events may be observed in the time-shift CMP gathers. FIG. 5A shows the flattened time-shift CMP gathers 502 from the model of FIG. 3A after parallel NMO correction. FIG. 5B shows the flattened time-shift CMP gathers 504 from the model of FIG. 3A after least-squares parallel NMO in accordance with embodiments of the disclosure. As shown in FIG. 5B, after correction using the derived trajectory as described in the disclosure, the events in the time-shift CMP gathers have been significantly flattened. This results in coherent stacking afterwards for constructing a seismic image.

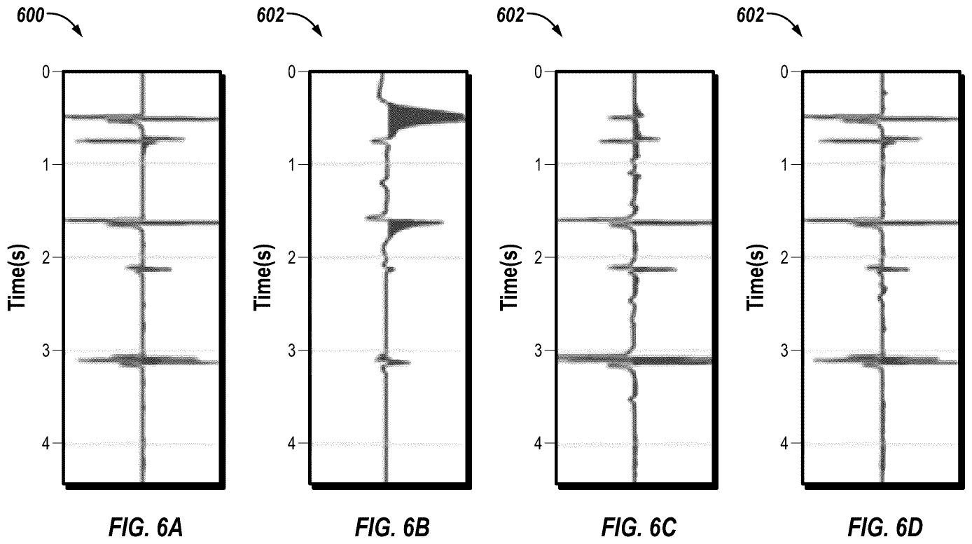

By way of example, FIG. 6A-D shows a comparison of stacked traces generated from the synthetic model 300 shown in FIG. 3A using different techniques. FIG. 6A depicts a stacked zero-offset trace 600 which is typically regarded as the benchmark stacked trace to evaluate other stacked traces. FIG. 6B depicts a stacked trace 602 after application of conventional NMO. As shown in FIG. 6B, the conventional NMO stacked trave exhibits significant stretching effects, especially at the shallow portion of the trace. FIG. 6C depicts a stacked trace 604 after application of parallel NMO and flattening. As shown in FIG. 6C, the stretching effects have been mostly removed, but the amplitude information is not preserved after stacking. Finally, FIG. 6D depicts a stacked trace 608 after application of least-squares parallel NMO and flattening in accordance with an embodiment of the disclosure. As shown in FIG. 6D, the stretching effects have been removed and the amplitude information is recovered after stacking. The comparison of FIG. 6D to FIG. 6C demonstrates that the least-squares parallel NMO is advantageous for lithology imaging as compared to parallel NMO which is only suitable for structure imaging.

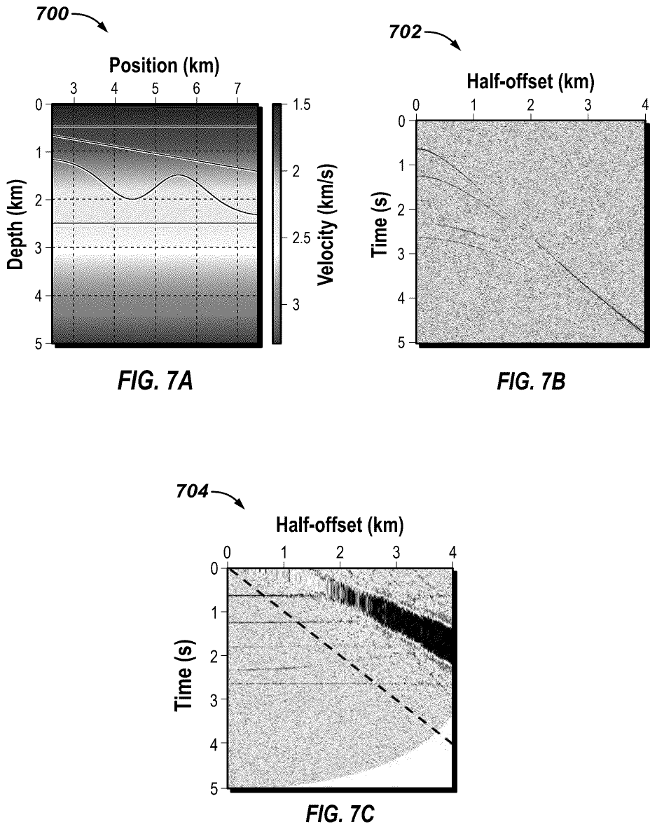

Additionally, embodiments of the disclosure were evaluated using a more complex model to demonstrate the effectiveness of the techniques of the disclosure. FIGS. 7A-7C, 8A-8B, and 9A-9D depict the processing and evaluation of the model using different NMO techniques. The complex model 700 is depicted in FIG. 7A, which shows a velocity model overlaid by several reflectors. FIG. 7B shows a synthetic common CMP gather 702 generated from the model of FIG. 7A and with added random noise. FIG. 7C shows a CMP gather 704 after application of conventional NMO correction to the CMP gather 702 of FIG. 7B. As shown in FIG. 7C, significant stretching effects are exhibited, especially at the upper portion of the red line. In the typical seismic data processing workflow, the area affected by the significant stretching is muted before stacking, and this procedure was adopted when generating the stack image.

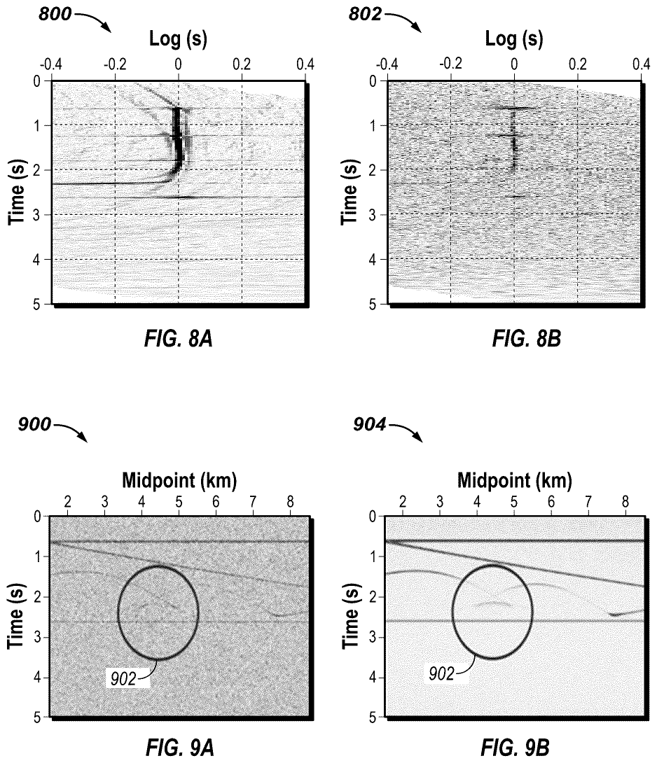

FIG. 8A shows the flattened time-shift CMP gathers 800 from the model 700 of FIG. 7A after parallel NMO correction. FIG. 8B shows the flattened time-shift CMP gathers 802 from the model of FIG. 7A after application of a least-squares parallel NMO correction in accordance with the techniques of the disclosure. As shown in FIG. 8B, all of the events in the time-shift CMP gathers have been significantly flattened.

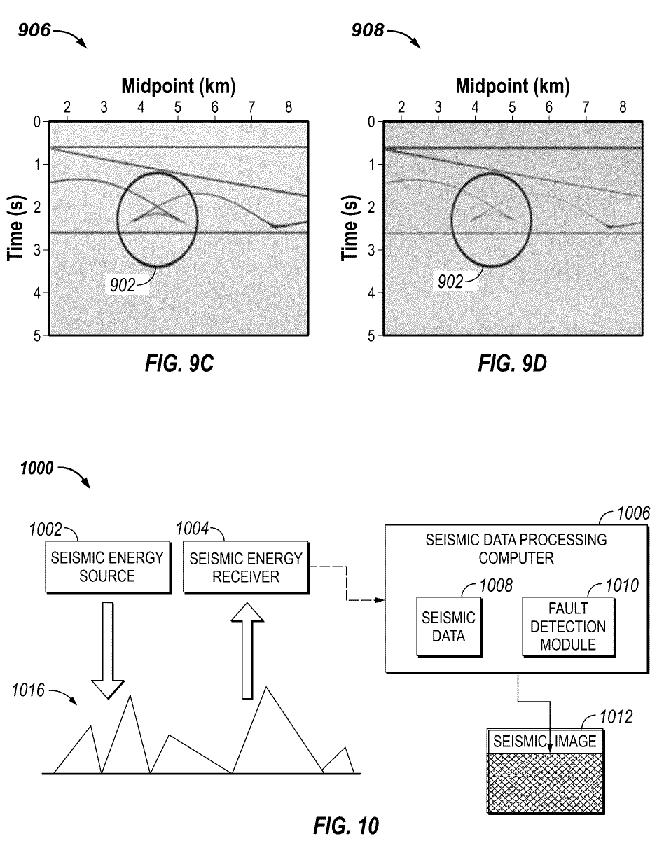

FIGS. 9A-9D shows a comparison of stacked images of the model of FIG. 7A using different techniques. FIG. 9A depicts a stacked zero-offset image 900 which is typically regarded as the benchmark to evaluate other stacked traces, with the area 902 in each of FIGS. 9A-9D further illustrative of the effects and improvements by comparison with each figure. As shown in FIG. 9A, the stacked zero-offset image is contaminated by random noise. FIG. 9B depicts a stacked image 904 after application of conventional NMO. As shown in FIG. 9B, the conventional NMO and stacking assists in increasing the signal-to-noise ratio (SNR) of the image. However, defining the area for muting stretching effects is challenging, and any muting may result in missing useful information. As shown in FIG. 9B some useful information has been lost during the muting of stretching effect areas. FIG. 9C depicts a stacked image 906 after application of parallel NMO and stacking of time-shift CMP gathers. As shown in FIG. 9C, the stretching effects have been reduced, and the stacked image has a greater SNR. Finally, FIG. 9D depicts a stacked image 908 after application of least-squares parallel NMO and stacking of flattened time-shift CMP gathers. As shown in FIG. 9D, the stretching effects have been further reduced and the SNR has been further enhanced. The comparison of FIG. 9C to FIG. 6D demonstrates that the stacked image after application of least-squares parallel NMO has a lower SNR but has improves preservation of the amplitude information, which may enable the interpretation of lithological properties.

FIG. 10 depicts a system 1000 for generating a seismic image using a least-squares parallel NMO correction and time-shift CMP gathers in accordance with an embodiment of the disclosure. The system 1000 can include, for example, a seismic source 1002 (also referred to as a “seismic station”), a seismic receiver 1006 (also referred to as a “receiver station”), a seismic data processing computer 1006 that stores and processes seismic data 1008, such as a shot gather responsive to seismic energy signals received by the seismic receiver, and a seismic image module 1010 with stretch-free NMO correction that generates a seismic image from seismic data produced by the seismic receiver 1006. Additionally, the seismic data processing computer 1006 may produce a stretch-free seismic image 1012 from seismic data according to the techniques described in the disclosure. The seismic source 1002 can include any seismic or acoustic energy whether from an explosive, implosive, swept-frequency or random sources. The seismic source, for example, can generate a seismic energy signal that propagates into the earth 1016.

Generally, the seismic source 1002 can emit seismic waves into the earth 1016 to evaluate subsurface conditions and to detect possible concentrations of oil, gas, and other subsurface minerals. Seismic waves may travel through an elastic body (such as the earth 1016). The propagation velocity of seismic waves may depend on the particular elastic medium through which the waves travel, particularly the density and elasticity of the medium as is known and understood by those skilled in the art. The refraction or reflection of seismic waves onto a seismic receiver 1004 can be used to research and investigate subsurface structures of the earth 1016. Embodiments of the system 1000 may include a plurality of seismic sources arranged in an array.

Accordingly, the seismic receiver 1004 can be positioned to receive and record seismic energy data or seismic field records in any form including, but not limited to, a geophysical time series recording of the acoustic reflection and refraction of waveforms that travel from the seismic source 1002 to the seismic receiver 1004. Variations in the travel times of reflection and refraction events in one or more field records in seismic data processing can produce seismic data 1008 that demonstrates subsurface structures and enables the identification of discontinuities in accordance with the embodiment described in the disclosure. Seismic images produced from the seismic image data may be used to aid in the search for, and exploitation of, subsurface mineral deposits in the geological structure.

Generally speaking, seismic receivers 1004 can record sound wave echoes (otherwise known as seismic energy signal reflections) that come back up through the ground from a seismic source 1002 to a recording surface. Such seismic receivers 1004 can record the intensity of such sound waves and the time it took for the sound wave to travel from the seismic source 1002 back to the seismic receiver 1004 at the recording surface. According to embodiments of the present disclosure, for example, during the seismic imaging process, the reflections of sound waves emitted by a seismic source 1002, and recorded by a seismic energy recording 1004, can be processed by a computer to construct a seismic image of structures in the earth 1016. The resulting seismic image of the subsurface can be used to identify, for example, the placement of wells and potential well flow paths.

More specifically, the term seismic receiver 1004 as is known and understood by those skilled in the art, can include geophones, hydrophones and other sensors designed to receive and record seismic energy. Accordingly, by placing a plurality of geophone seismic receivers 1004 at a recording surface, a two-dimensional seismic image can be produced responsive to seismic data recorded by the geophone seismic receivers 1004. Embodiments of the system 1000 may include a plurality of seismic receivers having a designated spacing between each receiver 1004.

According to an embodiment of the present disclosure, a seismic receiver 1004 can be positioned to receive and record seismic energy data or seismic field records in any form including a geophysical time series recording of the acoustic reflection and refraction of waveforms that travel from the seismic source 1002 to the seismic receiver 1004. Variations in the travel times of reflection and refraction events in one or more field records in a plurality of seismic signals can, when processed by the seismic data processing computer 1006, produce seismic data 1008 that demonstrates subsurface structure. As described herein, prior to using a seismic data 1008 to aid in the search for, and exploitation of, mineral deposits, the seismic data 1008 may be processed to generate a seismic image. The interpretation of the seismic image 1012 generated from such data may be used to determine the location of wells drilling into the earth 1016. Thus, one or more drills may be drilled into the earth 1016 in response to the generation and interpretation of the seismic image 1012.

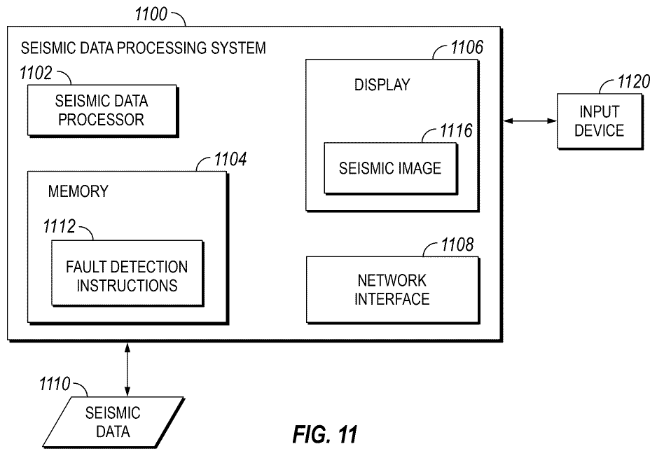

FIG. 11 depicts components of a seismic data processing computer 1100 in accordance with an embodiment of the disclosure. In some embodiments, seismic data processing computer 1100 may be in communication with other components of a system for obtaining and producing seismic data. Such other components may include, for example, seismic shot stations (sources) and seismic receiving stations (receivers). As shown in FIG. 11, the seismic data processing computer 1100 may include a seismic data processor 1102, a memory 1104, a display 1106, and a network interface 1108. It should be appreciated that the seismic data processing computer 1100 may include other components that are omitted for clarity. In some embodiments, seismic data processing computer 1100 may include or be a part of a computer cluster, cloud-computing system, a data center, a server rack or other server enclosure, a server, a virtual server, a desktop computer, a laptop computer, a tablet computer, or the like.

The seismic data processor 1102 (as used the disclosure, the term “processor” encompasses microprocessors) may include one or more processors having the capability to receive and process seismic data, such as data received from seismic receiving stations. In some embodiments, the seismic data processor 1102 may include an application-specific integrated circuit (AISC). In some embodiments, the seismic data processor 1102 may include a reduced instruction set (RISC) processor. Additionally, the seismic data processor 1102 may include a single-core processors and multicore processors and may include graphics processors. Multiple processors may be employed to provide for parallel or sequential execution of one or more of the techniques described in the disclosure. The seismic data processor 1102 may receive instructions and data from a memory (for example, memory 1104).

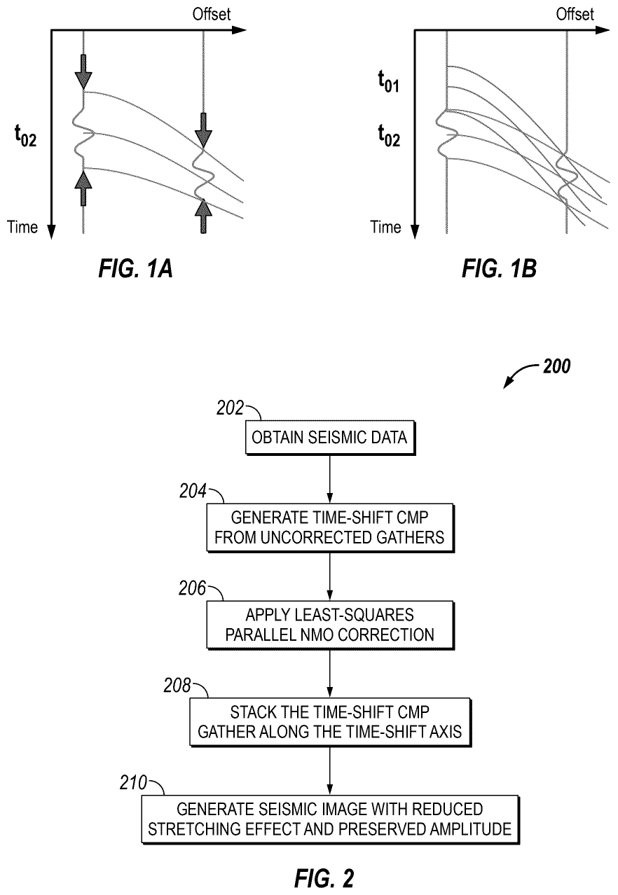

The memory 1104 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 1104 may be accessible by the seismic data processor 1102. The memory 1104 may store executable computer code. The executable computer code may include computer program instructions for implementing one or more techniques described in the disclosure. For example, the executable computer code may include stretch-free NMO seismic image instructions 1112 that define a seismic image module to implement embodiments of the present disclosure. In some embodiments, the stretch-free NMO seismic image instructions 1112 may implement one or more elements of process 100 described above and illustrated in FIG. 1. In some embodiments, the stretch-free NMO seismic image instructions 1112 may receive, as input, seismic data 1110 and may produce, as output, a stretch-free seismic image 1116. In some embodiments, the seismic image 1116 may be produced, stored in the memory 1104 and, as shown in FIG. 11, displayed on the display 1106.

The display 1106 may include a cathode ray tube (CRT) display, liquid crystal display (LCD), an organic light emitting diode (OLED) display, or other suitable display. The display 1106 may display a user interface (for example, a graphical user interface) that may display information received from the plant information processing computer 1106. In accordance with some embodiments, the display 1106 may be a touch screen and may include or be provided with touch sensitive elements through which a user may interact with the user interface.

The network interface 1108 may provide for communication between the seismic data processing computer 1100 and other devices. The network interface 1108 may include a wired network interface card (NIC), a wireless (e.g., radio frequency) network interface card, or combination thereof. The network interface 1108 may include circuitry for receiving and sending signals to and from communications networks, such as an antenna system, an RF transceiver, an amplifier, a tuner, an oscillator, a digital signal processor, and so forth. The network interface 1108 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (e.g., IEEE 802.11 standards), and other standards, protocols, and technologies. In some embodiments, for example, the unprocessed seismic data 1110 may be received over a network via the network interface 1108. In some embodiments, for example, the seismic image 1116 may be provided to other devices over the network via the network interface 1108.

In some embodiments, seismic data processing computer may be coupled to an input device 1120 (for example, one or more input devices). The input devices 1120 may include, for example, a keyboard, a mouse, a microphone, or other input devices. In some embodiments, the input device 1120 may enable interaction with a user interface displayed on the display 1106. For example, in some embodiments, the input devices 1120 may enable the entry of inputs that control the acquisition of seismic data, the processing of seismic data, and so on.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

1. A computer-implemented method for constructing a seismic image from seismic data generated from a seismic receiver station configured to sense seismic signals originating from a seismic source station, the method comprising:
obtaining the seismic data generated from the seismic receiver station;
generating time-shift common midpoint (CMP) gathers from the seismic data;
applying a least squared normal moveout (NMO) correction to the time-shift CMP gathers;
stacking the time-shift CMP gathers along a time-shift axis; and
constructing a seismic image from the stacked time-shift CMP gathers.

2. The method of claim 1, wherein stacking the time-shift CMP gathers along the time-shift axis comprises:
determining a trajectory of the time-shift CMP gather in the time domain; and
stacking along the determined trajectory.

3. The method of claim 1, wherein determining the trajectory of the time-shift CMP gather comprises:
$$t ( τ ) = {t}_{0} - τ ,$$
where t is the travel time at the time shift τ and t₀ is the two-way time at the zero offset.

4. The method of claim 3, wherein stacking along the determined trajectory comprises:
$$M ( {t}_{0} ) = \int I ( {t}_{0} - τ , τ ) d τ ,$$
where M(t₀) is the stacked trace, τ is the time shift, t₀ is the two-way time at the zero offset, and I is the time-shift gather.

5. The method of claim 1, wherein generating the time-shift common midpoint (CMP) gathers from the seismic data comprises:
$$I ( {t}_{0} , τ ) = \int d ( {t}_{0} + Δ t ( {t}_{0} , h ) + τ , h ) d h .$$
where I is the time-shift CMP gather, τ is the time shift, t₀ is the two-way time at the zero offset, and h is the source-to-receiver offset.

6. The method of claim 1, where applying the least squared normal moveout (NMO) correction to the time-shift common midpoint gathers comprises minimizing the following objective function:
$$J ( m ) = {‖ Lm - d ‖}^{2} ,$$
where m is the optimal time-shift common mid-point gather, d is the input common mid-point gather, L is the operator mapping from the time-shift CMP gather to an original CMP gather.

7. The method of claim 6, wherein L comprises the expression:
$$d ( {t}_{0} , h ) = \int I ( {t}_{0} - Δ t ( {t}_{0} , h ) - τ , τ ) d τ .$$
where I is the time-shift CMP gather, τ is the time shift, t₀ is the two-way time at the zero offset, and h is the source-to-receiver offset.

8. A non-transitory computer-readable storage medium having executable code stored thereon for constructing a seismic image from seismic data generated from a seismic receiver station configured to sense seismic signals originating from a seismic source station, the executable code comprising a set of instructions that causes a processor to perform operations comprising:
obtaining the seismic data generated from the seismic receiver station;
generating time-shift common midpoint (CMP) gathers from the seismic data;
applying a least squared normal moveout (NMO) correction to the time-shift CMP gathers;
stacking the time-shift CMP gathers along a time-shift axis; and
constructing a seismic image from the stacked time-shift CMP gathers.

9. The non-transitory computer-readable storage medium of claim 8, wherein stacking the time-shift CMP gathers along a time-shift axis comprises:
determining a trajectory of the time-shift CMP gathers in the time domain; and
stacking along the determined trajectory.

10. The non-transitory computer-readable storage medium of claim 8, wherein determining the trajectory of the time-shift CMP gathers comprises:
$$t ( τ ) = {t}_{0} - τ ,$$
where t is the travel time at the time shift τ and t₀ is the two-way time at the zero offset.

11. The non-transitory computer-readable storage medium of claim 10, wherein stacking along the determined trajectory comprises:
$$M ( {t}_{0} ) = \int I ( {t}_{0} - τ , τ ) d τ ,$$
where M(t₀) is the stacked trace, τ is the time shift, t₀ is the two-way time at the zero offset, and I is the time-shift gather.

12. The non-transitory computer-readable storage medium of claim 8, wherein generating time-shift common midpoint (CMP) gather from the seismic data comprises:
$$I ( {t}_{0} , τ ) = \int d ( {t}_{0} + Δ t ( {t}_{0} , h ) + τ , h ) d h .$$
where I is the time-shift CMP gather, τ is the time shift, t₀ is the two-way time at the zero offset, and h is the source-to-receiver offset.

13. The non-transitory computer-readable storage medium of claim 8, where applying a least squared normal moveout (NMO) correction to the time-shift common midpoint gathers comprises minimizing the following objective function:
$$J ( m ) = {‖ Lm - d ‖}^{2} ,$$
where m is the optimal time-shift common mid-point gather, d is the input common mid-point gather, L is the operator mapping from the time-shift CMP gather to an original CMP gather.

14. The non-transitory computer-readable storage medium of claim 13, wherein L comprises the expression:
$$d ( {t}_{0} , h ) = \int I ( {t}_{0} - Δ t ( {t}_{0} , h ) - τ , τ ) d τ .$$
where I is the time-shift CMP gather, τ is the time shift, t₀ is the two-way time at the zero offset, and h is the source-to-receiver offset.

15. A system, comprising:
a seismic source station;
a seismic receiver station configured to sense seismic signals originating from a seismic source station;
a seismic data processor;
a non-transitory computer-readable storage memory accessible by the seismic data processor and having executable code stored thereon for constructing a seismic image from seismic data generated from the seismic receiver station, the executable code comprising a set of instructions that causes the seismic data processor to perform operations comprising:
obtaining the seismic data generated from the seismic receiver station;
generating time-shift common midpoint (CMP) gathers from the seismic data;
applying a least squared normal moveout (NMO) correction to the time-shift CMP gathers;
stacking the time-shift CMP gathers along a time-shift axis; and
constructing a seismic image from the stacked time-shift CMP gathers.

16. The system of claim 15, wherein stacking the time-shift CMP gathers along a time-shift axis comprises:
determining a trajectory of the time-shift CMP gather in the time domain; and
stacking along the determined trajectory.

17. The system of claim 15, wherein determining the trajectory of the time-shift CMP gathers comprises:
$$t ( τ ) = {t}_{0} - τ ,$$
where t is the travel time at the time shift τ and t₀ is the two-way time at the zero offset.

18. The system of claim 17, wherein stacking along the determined trajectory comprises:
$$M ( {t}_{0} ) = \int I ( {t}_{0} - τ , τ ) d τ ,$$
where M(t₀) is the stacked trace, τ is the time shift, t₀ is the two-way time at the zero offset, and I is the time-shift gather.

19. The system of claim 15, wherein generating time-shift common midpoint (CMP) gather from the seismic data comprises:
$$I ( {t}_{0} , τ ) = \int d ( {t}_{0} + Δ t ( {t}_{0} , h ) + τ , h ) d h .$$
where I is the time-shift CMP gather, τ is the time shift, t₀ is the two-way time at the zero offset, and h is the source-to-receiver offset.

20. The system of claim 15, where applying a least squared normal moveout (NMO) correction to the time-shift common midpoint gathers comprises minimizing the following objective function:
$$J ( m ) = {‖ Lm - d ‖}^{2} ,$$
where m is the optimal time-shift common mid-point gather, d is the input common mid-point gather, L is the operator mapping from the time-shift CMP gather to an original CMP gather.

21. The system of claim 20, wherein L comprises the expression:
$$d ( {t}_{0} , h ) = \int I ( {t}_{0} - Δ t ( {t}_{0} , h ) - τ , τ ) d τ .$$
where I is the time-shift CMP gather, τ is the time shift, t₀ is the two-way time at the zero offset, and h is the source-to-receiver offset.
